(19) United States
(12) Patent Application Publication
(10) Pub. No.: US 2010/0232511 A1
(43) Pub. Date: Sep. 16, 2010

(54) MOTION COMPENSATOR, MOTION COMPENSATING METHOD, AND MOTION-COMPENSATED VIDEO DECODER IMPLEMENTING THE SAME

(75) Inventors: Shu Hsien Chou, Tainan (TW); Cheng-Yu Hsieh, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX MEDIA SOLTUIONS, INC., Tainan (TW)

(21) Appl. No.: 12/402,811

(22) Filed: Mar. 12, 2009

(51) Int. Cl. H04N 7/12; H04N 11/02

(52) U.S. Cl. 375/240.16; 375/240.24; 375/240.25; 375/E07.125; 375/E07.25; 375/E07.256

(57) ABSTRACT

A motion compensating method for a motion-compensated video decoder, the motion compensated video decoder having an entropy decoder for generation of MV information and MB modes, the motion compensating method includes selectively combining adjacent partitions within a macroblock in response to the MV information, and update the MV information and MB modes in response to the combination, and creating a predicted macroblock in response to the most updated MV information and MB modes.

### BACKGROUND

1. Technical Field

The embodiments described herein relate to video decoding, and more particularly, to motion compensation in video decoding.

2. Related Art

Recently, emerging standards, such as DivX, WMV9, and H.264 (MPEG-4 part 10), require fractional interpolation to sub-integer pixels and high density of motion vectors, thus requiring heavy memory loads. Particularly, the bottle neck for such standards in real-time or high quality video applications is always the speed and efficiency for motion compensation. Accordingly, fast and efficient motion compensation is desirable.

To accommodate fractional-pixel motion compensation, an area larger than the partition size is required to be fetched from the reference frame to accommodate the fractional-pixel motion compensation (MC). Moreover, as the partition size decreases, the overhead increases. The worst case occurs when each 8*8 partition is sub-divided into 4*4 sub-partitions, thereby resulting in a 406% of overhead. Accordingly, reduction of the number of small partitions would be helpful.

Various motion compensation designs have been developed to overcome the large calculation time of the complicated motion vector prediction (MVP) algorithm and high motion resolution in these standards, such as H.264/AVC. However, these designs are limited by the requirement of complex algorithms and control schemes to make use overlapped data between each motion compensation actions. Furthermore, these designs may require specific types of motion compensator.

Thus, there is a need for an adaptive design that can alleviate the memory bandwidth loading by motion compensation.

### SUMMARY

Comparison of MV information (including motion vectors & reference frame) of each partition with that of adjacent partitions and combining two partitions with identical MV information into one bigger partition are described herein.

In one aspect, a motion compensating method for a motion-compensated video decoder, the motion compensated video decoder having an entropy decoder for generation of MV information and MB modes, the motion compensating method includes selectively combining adjacent partitions within a macroblock in response to the MV information, and update the MV information and MB modes in response to the combination, and creating a predicted macroblock in response to the most updated MV information and MB modes.

In another aspect, a motion compensator for a motion-compensated video decoder, the motion compensated video decoder having an entropy decoder for generation of MV information and MB modes, includes a motion information processor configured to selectively combine adjacent partitions within a macroblock in response to the MV information and to update the MV information and MB modes in response to the combination, and a motion compensation processor configured to create a predicted macroblock in response to the most updated MV information and MB modes.

In another aspect, a motion compensated video decoder includes an entropy decoder configured to create a decoded bit-stream, MV information, and MB modes, an inverse quantizer and an inverse transform part configured to create a residual macroblock in response to the decoded bit-stream, a motion compensator having a motion information processor configured to selectively combine adjacent partitions in response to the MV information, and to update the MV information and MB modes in response to the combination, and a motion compensation processor configured to create a predicted macroblock in response to the most updated MV information and MB modes, and a summer configured to add the residual macroblock and predicted macroblock to create a reconstructed macroblock.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic block diagram of an exemplary motion compensated video decoding device according to one embodiment;

FIG. 2 is a schematic block diagram of an exemplary motion compensator of FIG. 1 according to one embodiment;

FIG. 3A is a schematic block diagram of an exemplary original 16*16 macroblock according to one embodiment;

FIG. 3B is a schematic block diagram of an exemplary processed 16*16 macroblock with two 8*4 partitions, one 8*8 partitions, and one 8*16 partition corresponding to the macroblock of FIG. 3A according to one embodiment;

FIG. 4 is a flowchart showing an exemplary operation of the motion compensation preprocessor of FIG. 2 according to one embodiment;

FIG. 5a is a schematic diagram showing exemplary motion compensation preprocess for a 4*4 macroblock according to one embodiment;

FIG. 5b is a schematic block diagram showing an exemplary 16*16 macroblock having each of 16 partitions as a 4*4 macroblock according to one embodiment;

FIG. 5c is a schematic block diagram showing four exemplary partitions I, II, III, and IV, each having an 8*8 intra macroblock according to one embodiment;

FIG. 5d is a flow chart showing an exemplary operation of the motion information processor according to one embodiment; and

FIG. 6 is a flow chart showing an exemplary operation of the motion information processor for forward and backward MV information and MB modes according to one embodiment.

### DETAILED DESCRIPTION

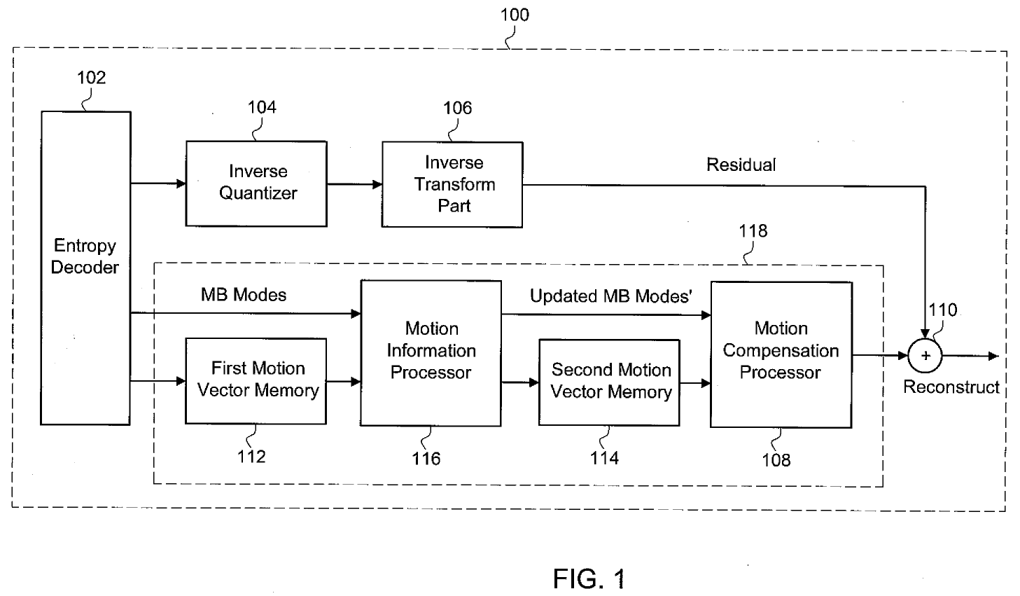

FIG. 1 is a schematic block diagram of an exemplary motion compensated video decoding device according to one embodiment. In FIG. 1, a motion compensated video decoding device 100 can be configured to include an entropy decoder 102 in which entropy coded image data is decoded, an inverse quantizer 104 and an inverse transform part 106, which restore the residual pixels for each macroblock, a motion compensator 118, and a summer 110. The motion compensator 118 can comprise first and second Motion Vector (MV) memories 112 and 114, a motion compensation processor 108, and a motion information processor 116.

In FIG. 1, the motion compensated video decoding device 100 can include a hybrid decoder, wherein the entropy decoder 102 can decode entropy encoded bit-stream data and can output Macroblock (MB) modes and MV information to the motion information processor 116 and the first motion vector memory 112, and can separate bit-steam data to the inverse quantizer 104. For example, the separate bit-stream data can be passed to the inverse quantizer 104 for inverse quantization (IQ) and passed to the inverse transform part 106 for inverse transform, which is an inverse discrete cosine transform (IDCT). The inverse transform part 106 provides a residual macroblock that is added at the summer 110 to the pixels of the corresponding predicted macroblock output from the motion compensator 118 in order to create a reconstructed bit-stream data. In the motion compensator 118, the motion information processor 116 can be configured to selectively combine adjacent partitions within a macroblock according to their MV information such that the number of small partitions to be processed by the motion compensation processor 108 can be reduced.

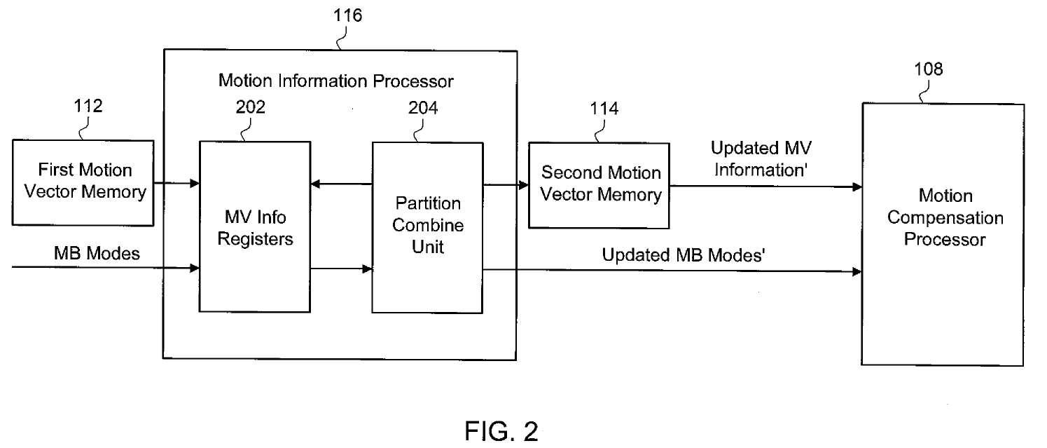

FIG. 2 is a schematic block diagram of an exemplary motion compensator of FIG. 1 according to one embodiment. In FIG. 2, the motion information processor 116 can be configured to reduce the number of small partitions to be processed by the motion compensation processor 108. For example, the motion information processor 116 can include a MV information register 202 and a partition combine unit 204, wherein the MV information register 202 can be configured to register MV information of the first MV memory 112 and MB modes. The partition combine unit 204 can be configured to read MV information and MB modes registered in the MV information register 202, selectively combine adjacent partitions within the macroblock, and update MV information and MB modes according to the combination. Accordingly, the updated MV information and MB modes can be passed to the motion compensation processor 108 for creation of the corresponding predicted macroblock. For example, the MV information register 202 can be further configured to keep the MV information of each partition in a 2N*2N block, wherein the size of the each partition can be N*N, 2N*N, or N*2N.

Exemplary operation of the partition combine unit 204 can include loading MV information of each partition within a macroblock and MB modes from the MV information register 202. Then, the MV information of each two partitions vertically or horizontally adjacent and with substantial equal size is compared. If the MV information of the two partitions vertically or horizontally adjacent and with substantial equal size is substantially identical, then the two partitions can be combined into one and update MV information and MB modes according to the combination can be created. Next, the updated MV information and MB modes are provided back to the MV information register 202, and the above steps are repeated until no two vertically or horizontally adjacent partitions with substantial equal size have substantially equal MV information.

In FIG. 2, the first MV memory 112 can be configured to buffer MV information and MB modes received from the entropy decoder 102 (in FIG. 1), and the second memory 114 can be configured to buffer the processed MV information and MB modes transferred to the motion compensation processor 108. After the combining the two vertically or horizontally adjacent partitions, the partition combine unit 204 can be further configured to send the new MV information to the second MV memory 114 and the new MB modes to the motion compensation processor 108.

When the MV information and MB modes may include both forward and backward MV information and MB modes, the partition combine 204 unit can be further configured to perform the above steps for updated forward MV information and MB modes and updated backward MV information and MB modes, respectively. The processed forward and backward MV information can be sent to the second MV memory 114, and the processed forward and backward MB modes can be sent to the motion compensation processor 108 afterwards.

Advantageously, memory bandwidth loading can be alleviated without requiring complex algorithms or control schemes to make use of overlapped data between each motion compensation actions. Moreover, it can be used along with any type of motion compensator, thus having substantial flexibility for application.

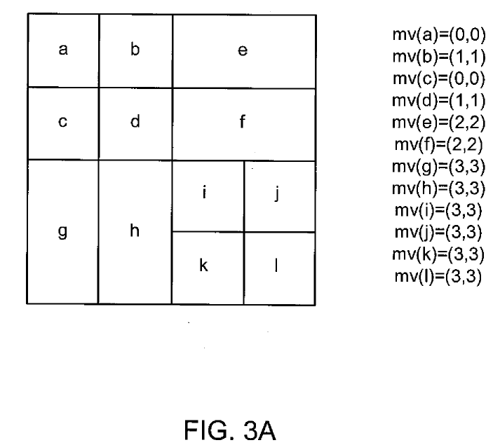

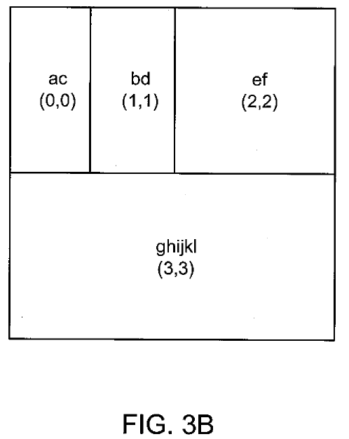

FIG. 3A is a schematic block diagram of an exemplary original 16*16 macroblock according to one embodiment, and FIG. 3B is a schematic block diagram of an exemplary processed 16*16 macroblock with two 8*4 partitions, one 8*8 partitions, and one 8*16 partition corresponding to the macroblock of FIG. 3A according to one embodiment. In FIG. 3A, the original 16*16 macroblock can have two 4*8 partitions (denoted as e and f), two 8*4 partitions (denoted as g and h), and 8 4*4 partitions (denoted as a˜d and i˜l). In FIG. 3B, a 16*16 macroblock, preprocessed by the motion information processor 116 of the motion compensator 118, can include two 8*4 partitions (ac and bd), one 8*8 partitions (ef), and one 8*16 partition (ghijkl). In the original 16*16 macroblock, both the MV information of partitions a and c are (0,0), those of partitions b and d are (1,1), those of partitions e and f are (2,2), those of partition g, h, i, j, k, and l are (3,3). Contrary to the original macroblock, here is generated the processed macroblock with only four partitions, partition ac, bd, ef, and ghijkl. Advantageously, the number of small partitions can be reduced, hence releasing the motion compensator from redundant computation.

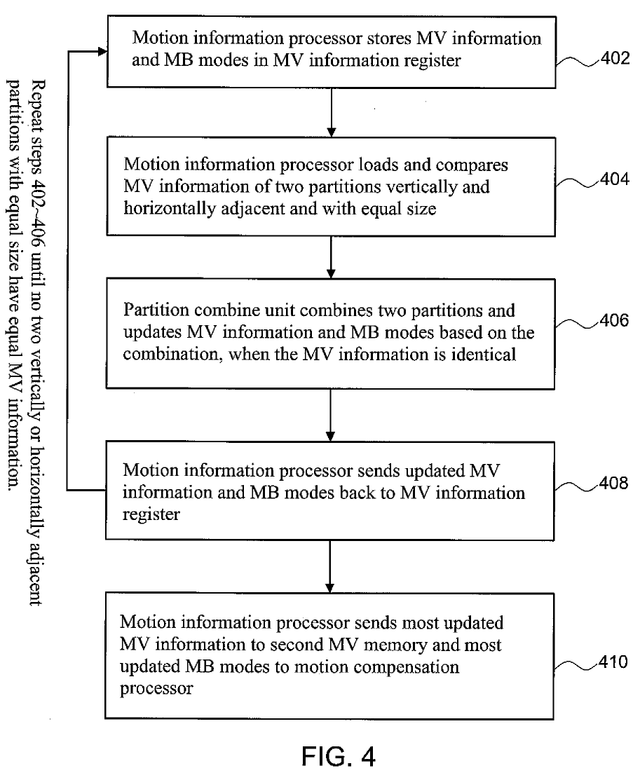

FIG. 4 is a flowchart showing an exemplary operation of the motion compensation preprocessor of FIG. 2 according to one embodiment. In FIG. 4, flow begins at block 402, wherein the motion information processor 116 registers MV information and MB modes in the MV information register 202. Here, the motion information processor 116 can register the MV information of each partition in a 2N*2N macroblock, and the size of each partition can be N*N, 2N*N, or N*2N. For example, the MV information register 202 can receive the MB modes from the entropy decoder 102 and MV information from the first MV memory 112. Alternatively, the MV information register 202 can receive the MB modes from the first memory 112, in which both MB modes and MV information is received from the entropy decoder 102.

Then, flow proceeds to block 404, wherein the motion information processor 116 loads and compares the MV information of two vertically or horizontally adjacent partitions with substantially equal size by the partition combine unit 204. Once the MV information of the two vertically or horizontally adjacent partitions is substantially identical, the motion information processor 116 would make a determination that the two vertically or horizontally adjacent partitions can be combined. Taking the partitions e and f (in FIG. 3A), for example, once the MV information of two partitions e and f loaded from the MV information register 202 is compared and determined to have substantially identical MV information, the partitions e and f may be combined to be one partition ef.

Next, flow proceeds to block 406, wherein the motion information processor 116 combines the two vertically or horizontally adjacent partitions by the partition combine unit 204, in response to the comparison described in block 404.

Then, flow proceeds to block 408, wherein the motion information processor 116 updates the MV information and MB modes in response to the combination described in block 406 and the updated MV information and MB modes of new partitions are sent back to the MV information register 202, and replaces those of the original partitions. Steps in blocks 402-406 are repeated until no two vertically or horizontally adjacent partitions with substantially equal size have substantially equal MV information.

Next, flow proceeds to block 410, wherein the motion information processor 116 sends the most updated MV information to the second MV memory 114 by the partition combine unit 204 and the most updated MB modes to the motion compensator 108 by the partition combine unit 204, and motion compensation can be performed by the motion compensation processor 108 in response to the updated MV information and MB modes.

Finally, flow ends after block 410.

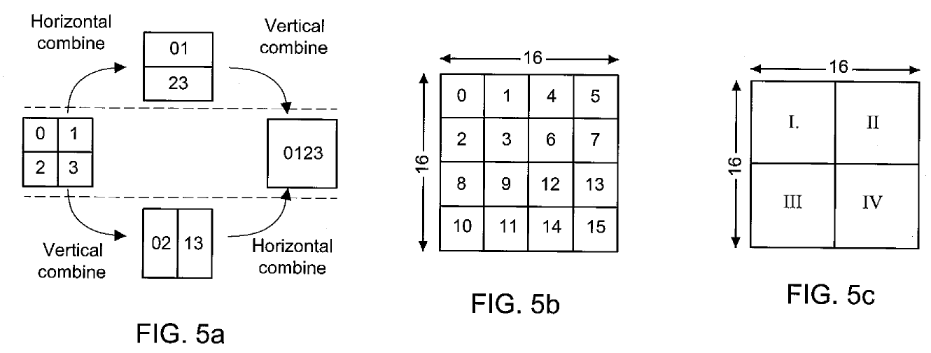

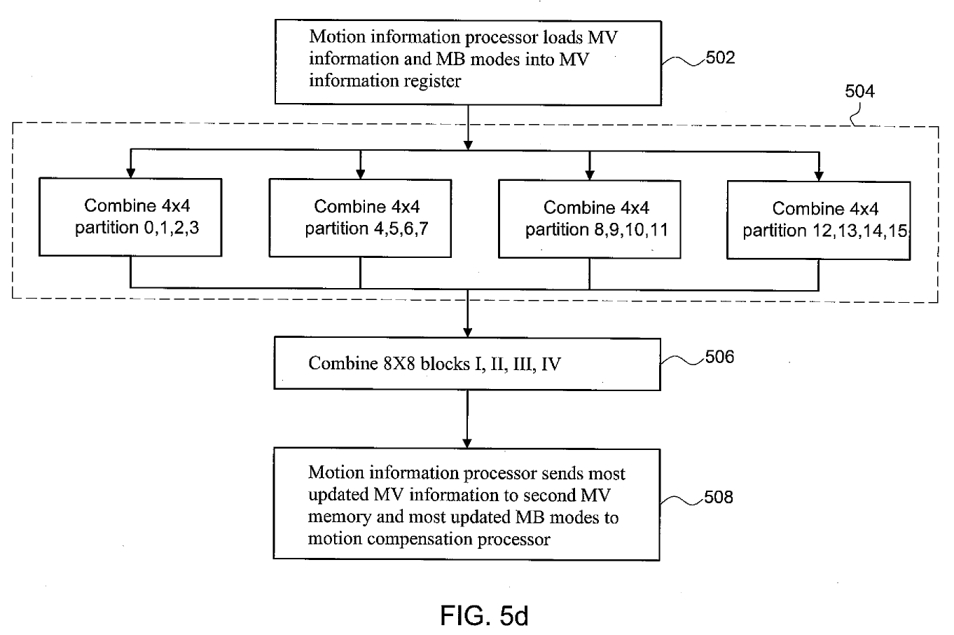

As shown in FIGS. 5a-d, a macroblock that is divided into partitions each can be proceed by the operation of the motion information processor 116 according to one embodiment. In FIGS. 5a and 5d, the word “combine” denotes the operation result of steps described in blocks 402-408 (in FIG. 4).

FIG. 5a is a schematic diagram showing exemplary motion compensation preprocess for a 4*4 macroblock according to one embodiment. In FIG. 5a, all of the MV information of partitions 1-4 is substantially identical. As described above with reference to FIG. 4, the motion information processor 116 may combine horizontally adjacent partitions first, then vertically adjacent partitions. Alternatively, the motion information processor 116 may combine vertically adjacent partitions first, then the horizontally adjacent partitions.

FIG. 5b is a schematic block diagram showing an exemplary 16*16 macroblock having each of 16 partitions as a 4*4 macroblock according to one embodiment. In FIG. 5b, each of the 16 partition is a 4*4 block and is denoted as partition 0-15. According to the specification for H.264/AVC, the 16 4*4 partitions can be combined to four blocks I, II, III, and IV, as described below with reference to FIG. 5c, wherein each of the blocks is an 8*8 block.

In FIG. 5c, the four exemplary partitions I, II, III, and IV can each having an 8*8 intra macroblock according to one embodiment.

FIG. 5d is a flow chart showing an exemplary operation of the motion information processor according to one embodiment. In FIG. 5d, flow begins at block 502, wherein the motion information processor 116 processes a macroblock similar to that described in FIG. 5b. Further, the MV information of the 16 4*4 partitions of the processed macroblock is assumed to be substantially identical.

At block 502, the motion information processor 116 registers MV information and MB modes in the MV information register 202. The steps of block 502 can be substantially similar to the steps in block 402 of FIG. 4, and are repeated for the sake of brevity.

At block 504, the motion information processor 116 separately combines each 4*4 partitions in each 8*8 block.

At block 506, the motion information processor 116 further combines the 8*8 blocks I, II, III, IV. Here, the combination steps in blocks 504 and 506 can be substantially similar to those described in FIG. 5a, and are not repeated for the sake of brevity.

Finally, at block 508, the motion information processor 116 updates MV information for transmission to the second MV memory 114 and updates the MB modes for transmission to the motion compensator 108 after the completion of combine process.

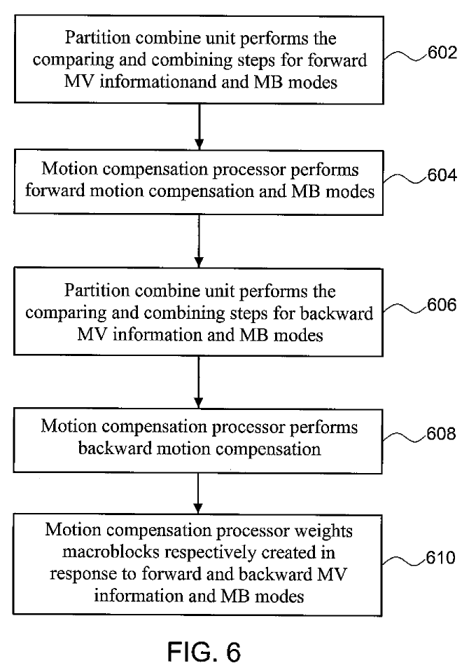

FIG. 6 is a flow chart showing an exemplary operation of the motion information processor for forward and backward MV information and MB modes according to one embodiment. In FIG. 6, flow begins at block 602, wherein the partition combine unit 204 performs the comparing and combining steps described in FIG. 5d for forward MV information and MB modes.

At block 604, the motion compensator 108 performs forward motion compensation in response to forward MV information and MB modes.

At block 606, the partition combine unit 204 performs the combination steps described in FIG. 5d for backward MV information and MB modes.

At block 608, the motion compensator 108 performs backward motion compensation in response to backward MV information and MB modes.

It should be understood that the backward process and motion compensation may also precede forward preprocess and motion compensation.

Finally, at block 610, the motion compensator 108 weights the outputs from forward and backward motion compensation to create the predicted macroblock. For example, the motion compensator 108 can average the outputs obtained from forward and backward motion compensation.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A motion compensating method for a motion-compensated video decoder, the motion compensated video decoder having an entropy decoder for generation of MV information and MB modes, the motion compensating method comprising:
selectively combining adjacent partitions within a macroblock in response to the MV information, and update the MV information and MB modes in response to the combination; and
creating a predicted macroblock in response to the most updated MV information and MB modes.

2. The method of claim 1, wherein the combining step further comprises:
(1) registering the MV information and MB modes;
(2) loading and comparing the MV information of two partitions vertically or horizontally adjacent and with substantially equal size;
(3) combining the two partitions when the MV information of the two partitions is determined to be substantially identical and updating the MV information and MB modes in response to the combination; and
(4) repeating steps (1) through (3) using the updated MV information and MB modes until no two partitions vertically or horizontally adjacent and with substantially equal size have substantially identical MV information.

3. The method of claim 2, wherein the registering step keeps the MV information of each partition in a 2N*2N macroblock, and the size of each partition is N*N, 2N*N, or N*2N.

4. The method of claim 2, wherein said MV information and MB modes includes forward and backward MV information and MB modes, the method further comprises:
performing steps (1) through (4) for forward MV information and MB modes;
creating a first macroblock in response to the forward MV information and MB modes;
performing steps (1) through (4) for backward MV information and MB modes;
creating a first macroblock in response to the backward MV information and MB modes; and
weighting the first and second macroblocks to create the predicted macroblock.

5. The method of claim 5, wherein said weighting step includes averaging the first and second macroblocks.

6. A motion compensator for a motion-compensated video decoder, the motion compensated video decoder having an entropy decoder for generation of MV information and MB modes, comprising:
a motion information processor configured to selectively combine adjacent partitions within a macroblock in response to the MV information and to update the MV information and MB modes in response to the combination; and
a motion compensation processor configured to create a predicted macroblock in response to the most updated MV information and MB modes.

7. The motion compensator of claim 6, wherein the motion information processor comprises:
a MV information register configured to register MV information and MB modes; and
a partition combine unit configured to:
(1) load and compare the MV information of two partitions vertically or horizontally adjacent and with substantially equal size from the MV information register;
(2) combine the two partitions when the MV information of the two partitions is determined to be substantially identical and update the MV information and MB modes in response to the combination;
(4) send the updated MV information and MB modes back to the MV information register; and
(5) repeat steps (1) through (4) until no two vertically or horizontally adjacent partitions with substantially equal size have substantially identical MV information.

8. The motion compensator of claim 7, wherein the MV information register is configured to keep the MV information of each partition in a 2N*2N block, wherein the size of the each partition is N*N, 2N*N, or N*2N.

9. The motion compensator of claim 7, wherein the MV information is loaded from a first MV memory storing the MV information output from the entropy decoder.

10. The motion compensator of claim 7, wherein the partition combine unit is further configured to:
(6) send the most updated MV information to a second MV memory and the new MB modes to the motion compensation processor.

11. The motion compensator of claim 7, wherein said MV information and MB modes includes forward and backward MV information and MB modes, and the partition combine unit further configured to:
perform steps (1) through (5) for the forward MV information and MB modes;
perform steps (1) through (5) for the backward MV information and MB modes; and
send the most updated forward and backward MV information to a second MV memory and the most updated forward and backward MB modes to the motion compensation processor.

12. The motion compensation preprocessor of claim 11, wherein the motion compensation processor is further configured to weight the macroblocks created in response to the forward and backward MV information and MB modes to create the predicted macroblock.

13. The motion compensation preprocessor of claim 12, wherein the motion compensation processor performs the weighting step by averaging macroblocks created in response to the forward and backward MV information and MB modes.

14. A motion compensated video decoder, comprising:
an entropy decoder configured to create a decoded bit-stream, MV information, and MB modes;
an inverse quantizer and an inverse transform part configured to create a residual macroblock in response to the decoded bit-stream;
a motion compensator, comprising:
a motion information processor configured to selectively combine adjacent partitions in response to the MV information, and to update the MV information and MB modes in response to the combination; and
a motion compensation processor configured to create a predicted macroblock in response to the most updated MV information and MB modes; and
a summer configured to add the residual macroblock and predicted macroblock to create a reconstructed macroblock.

15. The motion compensation video decoder of claim 14, wherein the motion information processor includes an MV information register to register the MV information and the MB modes.

16. The motion compensation video decoder of claim 15, wherein the motion information processor further includes a partition combine unit configured to load and compare the MV information of two partitions vertically or horizontally adjacent and with substantially equal size from the MV information register.

17. The motion compensation video decoder of claim 16, wherein the partition combine unit is configured to combine the two partitions when the MV information of the two partitions is determined to be substantially identical and update the MV information and MB modes in response to the combination.

18. The motion compensation video decoder of claim 17, wherein the partition combine unit is configured to send the updated MV information and MB modes back to the MV information register.

19. The motion compensation video decoder of claim 18, wherein the partition combine unit is configured to repeat the steps of loading and comparing, combining, and sending until no two vertically or horizontally adjacent partitions with substantially equal size have substantially identical MV information.

20. The motion compensation video decoder of claim 19, wherein the partition combine unit is configured to send the most updated MV information to a second MV memory and the new MB modes to the motion compensation processor.
